(19) United States
(12) Patent Application Publication
(10) Pub. No.: US 2010/0005198 A1
(43) Pub. Date: Jan. 7, 2010

(54) DATA INPUT/OUTPUT SYSTEM, DATA INPUT/OUTPUT SYSTEM CONTROL METHOD AND CONTROL APPARATUS

(75) Inventors: Shinya Satomi, Suita-shi (JP); Satoshi Deishi, Ibaraki-shi (JP); Yoshinori Sugahara, Kyoto-shi (JP)

Correspondence Address: SIDLEY AUSTIN LLP, 717 NORTH HARWOOD, SUITE 3400, DALLAS, TX, 75201, US

(73) Assignee: Konica Minolta Business Technologies, Inc., Tokyo (JP)

(21) Appl. No.: 12/447,489

(22) PCT Filed: Oct. 5, 2007
(86) PCT No.: PCT/JP2007/069575

§ 371 Date: Apr. 28, 2009

(30) Foreign Application Priority Data
Nov. 1, 2006 (JP) 2006-297508

(51) Int. Cl. G06F 3/00; G06F 3/048

(52) U.S. Cl. 710/16; 715/764

(57) ABSTRACT

A data input/output system, a data input/output system control method and a data input/output system control apparatus can be provided. In the data input/output system having input and output devices, it is determined and displayed whether an output device can output an input data received from an input device, thereby allowing the output device for outputting the input data to be easily selected with reliability by use of a minimum number of operations and thereby eliminating erroneous operations.

### TECHNICAL FIELD

The present invention relates to data input/output systems, control methods and control apparatuses of data input output systems, and in particular to data input/output systems, and control methods and control apparatuses of data input output systems which display data after making a judgment as to whether the output equipment can or cannot output the input data input from the input equipment.

### BACKGROUND TECHNOLOGY

In recent years, multiple function data input and output apparatuses called MFPs (Multi Functional Peripherals) are being used more and more widely instead of single function office equipment such as the conventional copying machines, printer, facsimile machines, etc., and in addition, there is the trend of advanced functions and multiple functions such as connection of MFPs to networks, etc. Along with this, it has become difficult for users to use the functions of MFPs due to the following reasons. 1. The user does not know what functions the MFP has. 2. The user does not know how to call the function that the user wishes to use. 3. The user does not know how to make the settings for the function that the user wishes to use.

In view of this, in order to solve the problems 1, 2, and 3 mentioned above, as a method of improving the operability of the operation and instruction section, a method has been proposed (for example, see Patent Document 1) for clearly displaying the keys that can be input next based on the selected mode status. Further, as a method of quickly carrying out the intended setting while preventing error statuses due to unnecessary input operations or wrong operations, a method has been proposed (for example, see Patent Document 2) for making it possible for the user to recognize the items that can be set, etc., by displaying in the display section whether or not it is possible to alter or execute the settings of setting items, preventing unnecessary input operations by the user, and making it possible to carry out accurately and quickly the prescribed settings.

In addition, even in cases in which there are multiple operations present simultaneously that can be selected as desired, as a method of appropriately indicating the procedure of those operations and reducing the operation load on the user, a method has been proposed (for example, see Patent Document 3) for controlling the lighting of the candidate keys for the next operation according to the key that was operated first, for establishing the sequence of operation, and lighting up the different keys accordingly.

Patent Document 1: Japanese Unexamined Patent Application Publication No. Hei 7(1995)-104903.

Patent Document 2: Japanese Unexamined Patent Application Publication No. 2005-122649

Patent Document 3: Japanese Unexamined Patent Application Publication No. 2005-316653

### DISCLOSURE OF THE INVENTION

### Problems to be Solved by the Invention

However, all of the above methods for Patent Documents 1, 2, and 3 are those which first make the user carry out all the settings related to the operation that the user wishes to make using the MFP, and after that the data input operation and output operation are made, and there is the problem that unless the user completes all the settings it is not possible to go to the actual data input operation.

The present invention was made in view of the above situation, and the purpose of the present invention is to provide a data input/output system, control method and control apparatus for a data input/output system in which it is possible to carry out the selection of output equipment for outputting the input data easily and definitely using the least possible operations, and to eliminate wrong operations.

### Means for Solving the Problems

The purpose of the present invention can be achieved by the following structures.

1. A data input/output system comprising: a plurality of input equipments to input data; a plurality of output equipments to output data; a data control section that is connected to said plurality of input equipments and said plurality of output equipments, and receives input data that has been input from any of said plurality of input equipments, and outputs the received input data to any of said plurality of output equipments; an output possible/not possible judgment section that receives information related to each of the output equipment from said plurality of output equipments, compares information related to said input data associated with the input data with the received information related to each of the output equipment , and judges whether or not it is possible to output the input data in each of the output equipment; a display apparatus; and a display control section that displays in said display apparatus the results of judgment by said output possible/not possible judgment section

2. A data input/output system according to 1, wherein said display control section displays the results of judgment by said output possible/not possible judgment section in said display apparatus so that it is possible to distinguish said output equipment in which it is not possible to output said input data.

3. A data input/output system according to 1, said display control section displays the results of judgment by said output possible/not possible judgment section in said display apparatus so that it is possible to distinguish said output equipment in which it is possible to output said input data.

4. A data input/output system according to 1, wherein said display control section displays in said display apparatus only said output equipment in which it is possible to output said input data.

5. A data input/output system according to 1, further comprising: an operation apparatus to input information that is used for outputting the input data in said output equipment; and an operation control section that
obtains the information related to the selection of the output equipment that is input from said operation apparatus, when a plurality of output equipment are present in which it is possible to output said input data according to the results of judgment by said output possible/not possible judgment section, and sets the output equipment that has been selected as the output equipment in which said input data has to be output.

6. A data input/output system according to 5, wherein said operation control section obtains information related to the parameter settings of said input equipment which is input from said operation apparatus.

7. A data input/output system according to 5, wherein said operation control section obtains information related to the parameter settings of said output equipment which is input from said operation apparatus.

8. A data input/output system according to 6, wherein said output possible/not possible judgment section, based on the information related to the parameter settings of said input equipment obtained from said operation control section, judges whether or not said output equipment can output said input data.

9. A data input/output system according to 7, wherein said output possible/not possible judgment section, based on the information related to the parameter settings of said output equipment obtained from said operation control section, judges whether or not said output equipment can output said input data.

10. A data input/output system according to 5, wherein said operation apparatus is a touch panel placed above said display apparatus.

11. A control method of a data input/output system, the system comprising: a plurality of input equipments to input data; a plurality of output equipments to output data; a data control section that is connected to said plurality of input equipments and said plurality of output equipments, receives input data that has been input from any of said plurality of input equipment, and outputs the received input data to any of said plurality of output equipment; and a display apparatus, the method comprising: an input step of inputting data; an output information reception step of receiving the information related to said output equipment from said plurality of output equipments, an output possible/not possible judgment step of comparing information related to the input data associated with the input data received during said input step with the information related to said plurality of output equipment that has been received during said output information reception step, and judging whether or not said plurality of output equipments can output the input data; and an output possible/not possible display step of displaying in said display apparatus the results of judgment made during said output possible/not possible judgment step.

12. A control apparatus of a data input/output system provided with a plurality of input equipments for inputting data and a plurality of output equipments for outputting data, the control apparatus comprising;

a data control section that is connected to said plurality of input equipments and said plurality of output equipments, receives input data that has been input from any of said plurality of input equipments, and outputs said the received input data to any of said plurality of output equipments;

an output possible/not possible judgment section that receives information related to each of the output equipment from said plurality of output equipments, compares the information related to said input data associated with the input data with the received information related to each of said plurality of output equipments, and judges whether or not that each of the said output equipment can output said input data; a display apparatus; and a display control section that displays in said display apparatus the results of judgment made by said output possible/not possible judgment section.

### EFFECT OF THE INVENTION

According to the present invention, in a data input/output system provided with input equipment and output equipment, by judging and displaying whether or not the output equipment can output the input data input from the input equipment, it is possible to provide a data input/output system, a data input/output system control method and control apparatus with which the selection of the output equipment for outputting the input data can be made easily and definitely with the least number of operations, and wrong operations are eliminated.

### BRIEF DESCRIPTION OF THE DRAWINGS

FIG. 1 is a functional block diagram showing a preferred embodiment of a data input/output system.

FIG. 2 is a main routine of a flow chart showing the flow of data input/output operation in a data input/output system.

FIG. 3 is a subroutine (⅓) of FIG. 2.

FIG. 4 is a subroutine (⅔) of FIG. 2.

FIG. 5 is a subroutine ( 3/3) of FIG. 2.

FIG. 6 is a schematic diagram showing an example of an input equipment selection screen.

FIG. 7 is a schematic diagram showing an example of an input parameter list and input parameter setting screen.

FIG. 8 is a schematic diagram showing an example of a list of the data formats that can be processed.

FIG. 9 is a schematic diagram showing an example of an output function list and a first example of an output equipment selection screen.

FIG. 10 is a schematic diagram showing an example of an output parameter list and output parameter setting screen.

FIG. 11 is a schematic diagram showing a second and a third example of an output equipment selection screen.

### DESCRIPTION OF SYMBOLS

1 Data input/output system
101 Data control section
111 Input equipment control
113 Input data
121 Output equipment control
123 Output data
201 Display and operation comprehensive section
211 Display control section
213 Display control signal
221 Display apparatus
231 Operation control section
241 Operation apparatus
243 Operation information
301 Function of input from scanner
303 Fax reception function
305 Function of data reception from a digital camera (DSC)
307 Function of data reception from a server, a personal computer (PC), or storage
309 Function of data reception from other data input/output apparatuses (MFP) or other data input/output systems
311 Mail reception function
313 Function of data reception from other users
331 Function of printing from a printer
333 Fax transmission function
335 Function of displaying on a TV
337 Function of data transmission to a server, a personal computer (PC), or storage
339 Function of data transmission to other data input/output apparatuses (MFP) or other data input/output systems
341 Mail transmission function
343 Function of data transmission to other users
345 Function of discarding to the recycle bin
IS Input equipment selection screen
IPL Input Parameter List
IPS Input Parameter Setting Screen
ADL List of data formats that can be processed
OCL Output functions list
OS Output equipment selection screen
OPL Output parameter list
OPS Output parameter setting screen

### DESCRIPTION OF THE PREFERRED EMBODIMENTS OF THE INVENTION

Although the present invention is described in the following based on some preferred embodiments shown in the drawings, the present invention shall not be restricted to these preferred embodiments. Further, identical or equivalent parts in the figures have been given the same symbols and their duplicate explanations have been omitted.

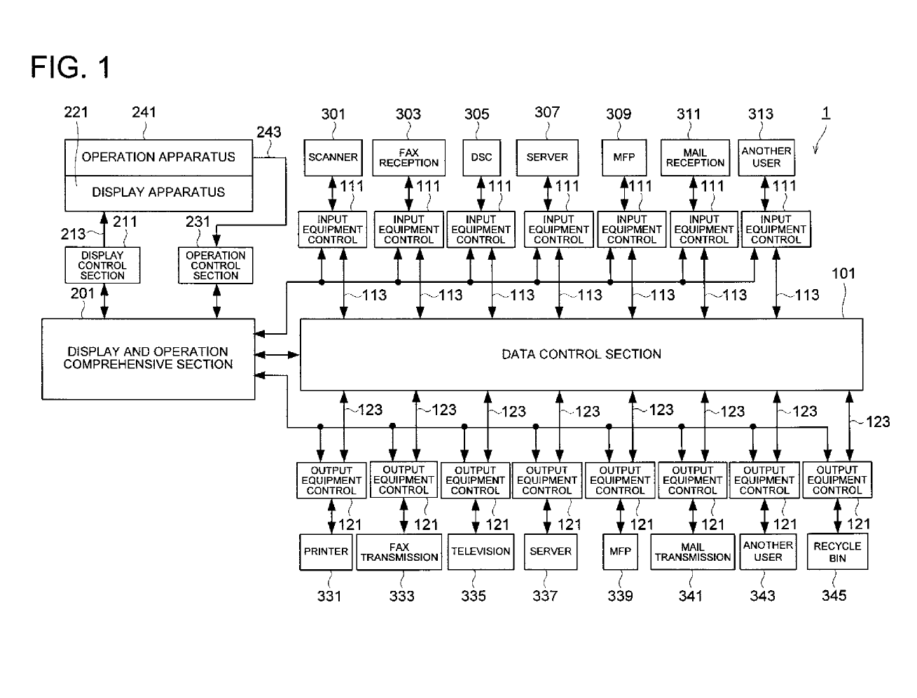

To begin with, a preferred embodiment of a data input/output system according to the present invention is explained referring to FIG. 1. FIG. 1 is a functional block diagram showing a preferred embodiment of a data input/output system. In FIG. 1, the data input/output system 1 has, as input functions, various functions such as the function 301 of input from scanner, the fax reception function 303, the function 305 of data reception from a digital camera (DSC), the function 307 of data reception from a server, or a personal computer (PC), or storage, the function 309 of data reception from another data input/output apparatus (MFP) or another data input/output system, the mail reception function 311, and the function 313 of data reception from other users.

Further, as the output functions, it has the function 331 of printing from a printer, the fax transmission function 333, the function 335 of displaying on a TV, the function 337 of data transmission to a server, or to a personal computer (PC), or to a storage apparatus, the function 339 of data transmission to another data input/output apparatus (MFP) or to another data input/output system, the mail transmission function 341, the function 343 of data transmission to other users, and the function 345 of discarding to the recycle bin. The data input/output system 1, by executing combinations of these input functions and output functions, provides services to the user. The combinations of input and output functions can be one to one, one to many, many to one, or many to many.

The different types of input functions described above and the data control section 101 are connected by the input equipment control 111, and similarly, the different types of output functions and the data control section 101 are connected by the output equipment control 121. The input equipment control 111 and the output equipment control 121 are control programs that are prepared for the above described different input/output functions and for the input/output equipment for carrying out the different input/output functions, and carry out the input/output operations by controlling the different input/output functions and input/output equipment.

Although the different inputs and outputs were defined as functions, there are no particular restrictions on the connections between the data input/output system 1 and the different input/output equipment, and any state of connection is possible as long as the function can be realized. For example, if the function 301 of input from scanner can be realized, the scanner itself may be connected directly with the data input/output system 1, or can be connected via a network. Furthermore, as long as the function can be realized, it is possible that there is no dedicated equipment for realizing that function. For example, if the fax transmission and reception functions can be performed, even if there is no facsimile equipment, for example, the fax transmission and reception functions can be substituted by a PC. Further, since each input/output function can also be added to or removed from the data input/output system 1 selectively, in the state in which all the input/output functions have been isolated from the data input/output system 1, the control apparatus of the data input/output system 1 is constituted.

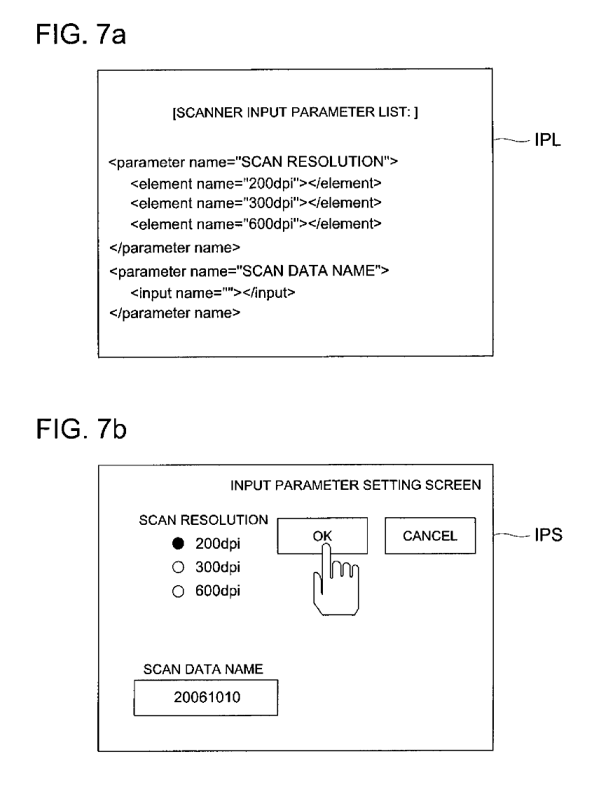

In addition, the input equipment control 111 retains the list ADL of the data formats that can be processed which list indicates the data formats that can be processed by the different input functions or the input equipment, the input parameter list IPL for setting the different input functions or the input equipment at the time of data input, and the output control 121 retains the list ADL of the data formats that can be processed which list indicates the data formats that can be processed by the different output functions or the output equipment, the output parameter list OPL for setting the different output functions or the output equipment at the time of data output. Detailed explanations are given from FIG. 7 onwards regarding the list ADL of the data formats that can be processed, the input parameter list IPL, and the output parameter list OPL.

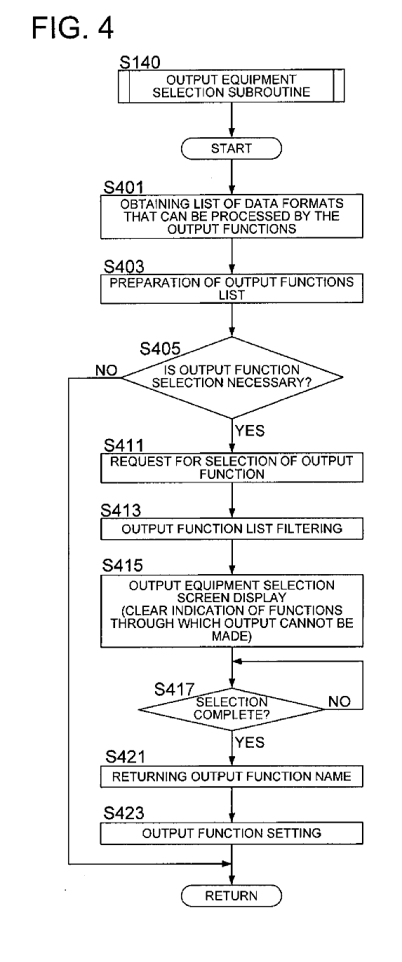

The data control section 101 receives the input data 113, which has been input by the different input equipment, from the input equipment control 111 which controls the different input functions, and transmits the received input data 113 as the output data 123 to the output equipment control 121 which controls the output function that has been selected as the output destination. During the selection of the output destination, the data control section 101, either alone or in coordination with the display and operation comprehensive section 201, based on the information related to the input data 113 that is associated with the input data 113 and the information related to the different output functions that are possessed by the output equipment control 121, judges whether or not each output function can output the input data 113. The data control section 101 and the display and operation comprehensive section 201 function as the output possible/not possible judgment section. Further, the method of selecting the output destination is described in detail in the explanations of FIG. 4.

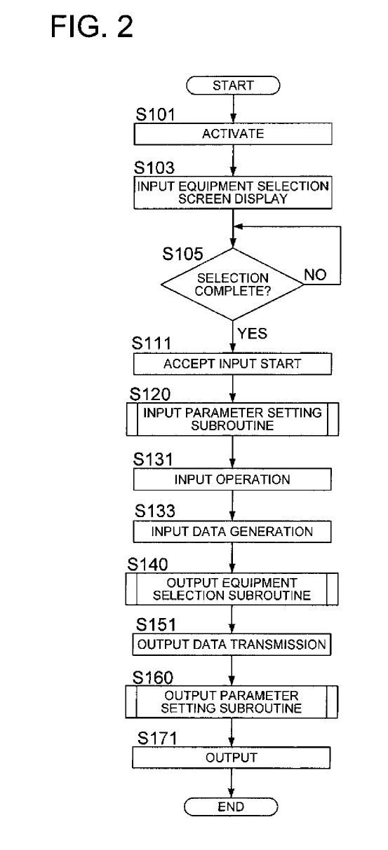

The display and operation comprehensive section 201, based on a request from either the input equipment control 111, the data control section 101, or the output equipment control 121, by displaying in the display apparatus 221 via the display control section 211-(1) the selection screen of input equipment, (2) the parameter setting screen of input equipment, (3) the selection screen of output equipment, and (4) the parameter setting screen of output equipment, makes the user carry out, using the operation apparatus 241, the operations of—(1) selection of the input equipment, (2) parameter setting of the input equipment, (3) selection of the output equipment, and (4) parameter setting of the output equipment, receives the selection detected by the operation control section 231 or the different operation information 243 that has been set via the operation control section 231, and returns to any one of the requesting party among the input equipment control 111, the data control section 101, or the output equipment control 121. The details are described in the explanations of FIG. 2 and beyond.

The display apparatus 221 is configured, for example, using a liquid crystal display, etc., and is one that can display characters or images following the display control signal 213 from the display control section 211. The operation apparatus 241, for example, is a touch panel that is placed on top of the screen of the display apparatus 221, and by touching the operation apparatus 241 on top of the characters or images displayed in the display apparatus 221, the user can carry out various operations of selection, input, deleting, moving, etc., on the screen. The different operation information 243 such as that of selection, input, deleting, moving, etc., made using the operation apparatus 241 is detected by the operation control section 231, and is transmitted to the display and operation comprehensive section 201.

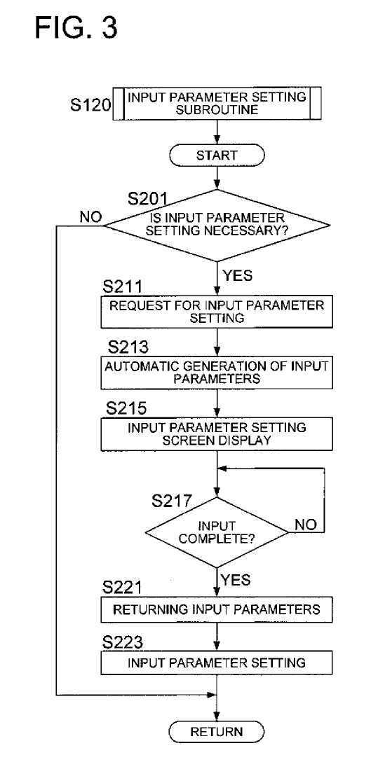

Next, a preferred embodiment of the data input/output operation in a data input/output system 1 is explained referring to FIGS. 2 to 10. FIGS. 2 to 5 are flow charts showing the flow of input/output operation of data in a data input/output system 1, wherein FIG. 2 is the main routine, and FIGS. 3 to 5 are subroutines of FIG. 2. Here, although the explanations are given taking the example of the so called copying operation as the data input/output operation, in which paper original documents are input using a scanner, and the output is made from a printer, the thinking behind the operations is the same even in other input/output operations.

In FIG. 2, in Step S101, when the data input output system 1 is activated either by switching ON the power supply of the data input/output system 1, or by inputting a start command, etc., in Step S103, upon a request from the data control section 101, the input equipment selection screen IS is displayed in the display apparatus 221 via the display control section 211 by the display and operation comprehensive section 201.

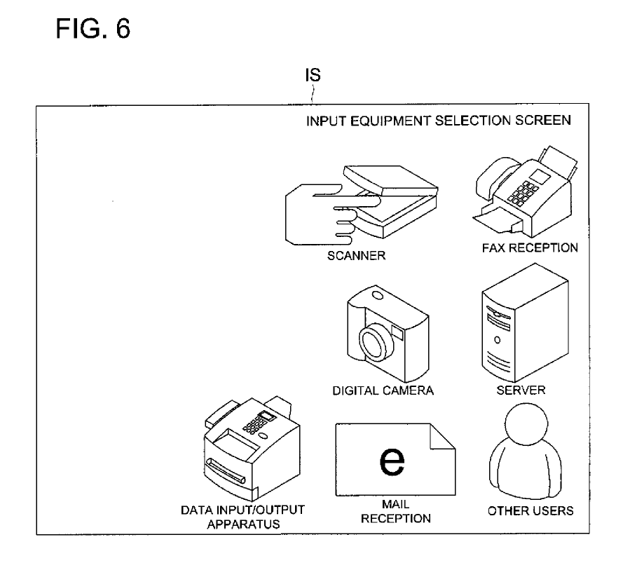

Here, the input equipment selection screen IS, is a screen such as the example shown in FIG. 6, in which are displayed diagrams (hereinafter called icons) representing all the input functions that can be used among the input functions provided in the data input/output system 1 (in this example, the function 301 of input from scanner, the fax reception function 303, the function 305 of data reception from a digital camera (DSC), the function 307 of data reception from a server, or a personal computer (PC), or storage, the function 309 of data reception from another data input/output apparatus (MFP) or another data input/output system, the mail reception function 311, and the function 313 of data reception from other users), and this screen prompts the user to select the input function.

In Step S105, a confirmation is made as to whether or not the selection of the input function has been completed. The operation waits at Step S105 until the selection has been completed. Here, it is considered that the function 301 of input from a scanner has been selected by the user as the input function. Step S103 and Step S105 function as the input equipment selection step. When the selection has been completed (YES in Step S105), a paper original document has been placed by the user on the document receiver of the scanner, and the Start Scan button of the scanner is pressed, in Step S111, the fact that the Start Scan button of the scanner has been pressed is detected by the input equipment control 111 of the scanner, and the start of the input from the scanner is accepted.

Alternatively, even if the selection of an input equipment has not been made by the user in the input equipment selection screen IS but a paper original document has been placed by the user on the document receiver of the scanner, and the Start Scan button of the scanner has been pressed, if the fact that the Start Scan button of the scanner has been pressed is detected by the input equipment control 111 of the scanner, it is also possible to accept the start of the input from the scanner.

In Step S120, the “input parameter setting subroutine” shown in FIG. 3 is executed, and the input parameters necessary at the time of input by the scanner are set. The Step S120 functions as the input parameter setting step.

In Step S131, based on the input parameters set in Step S120, the scanning of the paper original document placed on the document receiver of the scanner is carried out, and in Step S133, the scan data of the original document is generated by the input equipment control 111 of the scanner, and is transmitted as the input data 113 to the data control section 101. The Step 131 and Step 133 function as the input step.

In Step S105, if it is considered, for example, that email reception has been selected, in Step S120, a screen asking for the input by the user of the user's personal identification code (the so called user ID) or mail address, password, etc., is displayed in the display apparatus 221, and based on the information input by the user, the email is received from the main server in Step S131, and the input data 113 is generated in Step S133.

In Step S140, the “output function selection subroutine” shown in FIG. 4 is executed, and if it is considered, for example, that a printer has been selected as the output equipment, in Step S151, the input data 113 is transmitted as the output data 123 from the data control section 101 to the output equipment control 121 that controls the printer selected in Step S140.

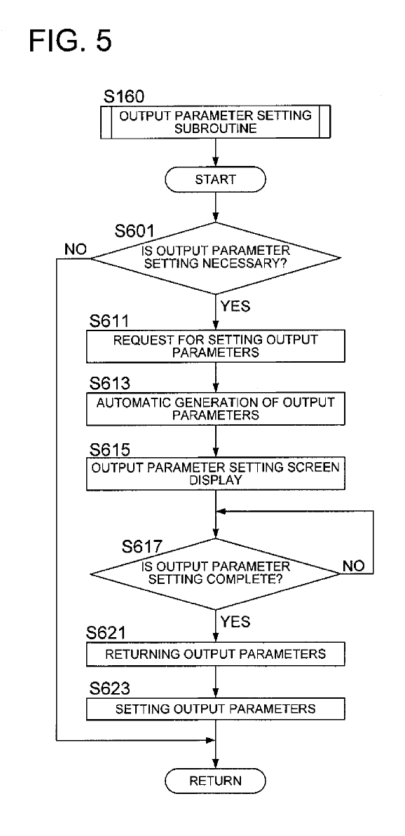

Subsequently, in Step S160, the “output parameter setting subroutine” shown in FIG. 5 is executed, and the output parameters necessary during output by the printer are set. The Step S160 functions as the output parameter setting step. In Step S171, based on the parameters set in Step S160, the output data 123 is printed out by the printer. The Step S151 and S171 function as the output step.

FIG. 3 is the Step S120 “input parameter setting subroutine” of the main routine of FIG. 2.

In FIG. 3, in Step S201, the input parameter list IPL of the scanner retained by the input equipment control 111 of the scanner is referred to, and a judgment is made by the input equipment control 111 of the scanner as to whether or not any parameter settings are necessary during the input using the scanner.

Here, the input parameter list IPL is a list such as the example shown in FIG. 7(a), and for example, in the case of a scanner, in this list, it is possible to set a plurality of scan resolutions such as 200 dpi, 300 dpi, 600 dpi, etc., and there are parameters such as using the name input by the user as the name of the scanned data, etc.

If, at the time of input using a scanner, all the parameters have already been determined unambiguously, and if there is no need for making any parameter settings (NO in Step S203), the operation returns as it is to Step S120 of the main routine of FIG. 2.

In this example, from the input parameter list IPL of the scanner shown as an example in FIG. 7(a), it is judged by the input equipment control 111 of the scanner that the settings of the two parameters of “scan resolution” and “scan data name” are necessary (YES in Step S203), and in Step S211, the settings of the two parameters of “scan resolution” and “scan data name” are requested by the input equipment control 111 of the scanner to the display and operation comprehensive section 201.

In Step S213, by the display and operation comprehensive section 201, the parameters that can be generated automatically among the parameters whose setting was requested in Step S211 are generated automatically (here, it is assumed that the “scan data name” is generated automatically from the date as, for example, “20061010”), and in Step S215, the input parameter setting screen IPS is displayed in the display apparatus 221 via the display control section 211 by the display and operation comprehensive section 201.

Here, the input parameter setting screen IPS is a screen such as the example shown in FIG. 7(b), and is a screen in which the parameters for which inputs are required from the user (here, the parameter “scan resolution”) and the parameters whose settings have been generated (here, the parameter “scan data name”) automatically by the display and operation comprehensive section 201 are displayed. The user not only inputs the values (for example, selection of “200 dpi”) of the requested parameter settings (“scan resolution”) using the operation equipment 241, but also can change, if necessary, the parameters that have been generated automatically (“scan data name”).

In Step S217, a confirmation is made as to whether or not the input of the parameters has been completed. The completion of parameter input is confirmed, for example, by the pressing of the “OK” button by the user in the input parameter setting screen IPS being detected by the operation control section 231. The operation waits at Step S217 until the input has been completed. When the parameter input has been completed (YES in Step S217), in Step S221, the two parameters “scan resolution” and “scan data name” are returned by the display and operation comprehensive section 201 to the input equipment control 111 of the scanner, and in Step S223, the parameters are set in the scanner by the input equipment control 111 of the scanner, and the scanning of the original document is started by returning to Step S120 of the main routine.

FIG. 4 is the Step S140 “output function selection subroutine” of the main routine of FIG. 2.

In FIG. 4, in Step S401, the list ADL of data formats that can be processed which list describes the data formats that can be output by each of the output functions is obtained by the data control section 101 from each of the output equipment controls 121. The Step S140 functions as the output information reception step. In Step S403, that lists ADL of data formats that can be processed obtained in Step S401 from each of the output functions are compared with the data format of the input data 113 transmitted in Step S133 of FIG. 2 from the input equipment control 111 that controls the scanner, the output functions that can be processed and the output functions that cannot be processed are discriminated, and the list OCL of output functions is prepared from the results of this discrimination.

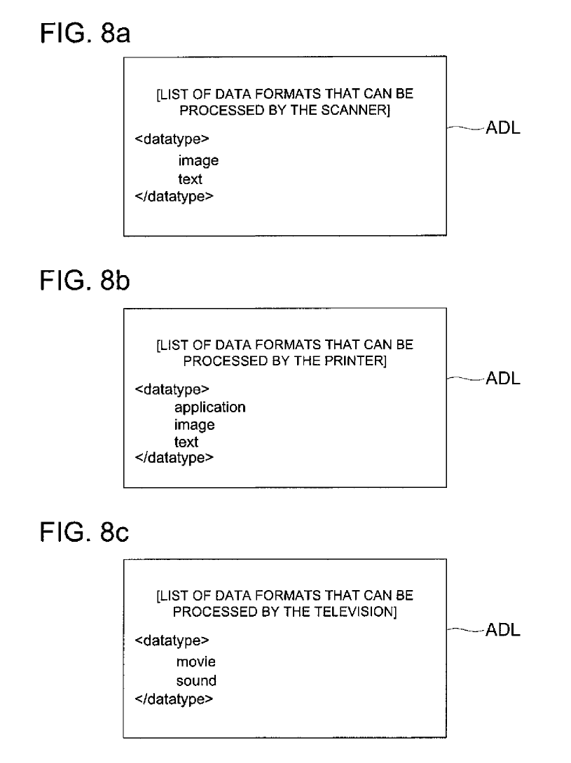

Here, the list ADL of data formats that can be processed is a list such as the one shown in FIG. 8, and is a list describing the data formats that can be processed by each of the input/output functions such as, for example, that images and texts can be processed in the case of the function 301 of input from a scanner (FIG. 8(a)), and in the case of the function 331 of printing from a printer, in addition to the images and texts identical to a scanner, that it is also possible to carry out the processing of output to an application program, and similarly, in the case of the function 335 of output to a TV, that it is possible to process movies and sounds. The lists ADL of the data formats that can be processed are retained by each of the input equipment control 111 that controls each of the input equipment or by each of the output equipment control 121 that controls each of the output equipment, and are provided as and when necessary to the data control section 101.

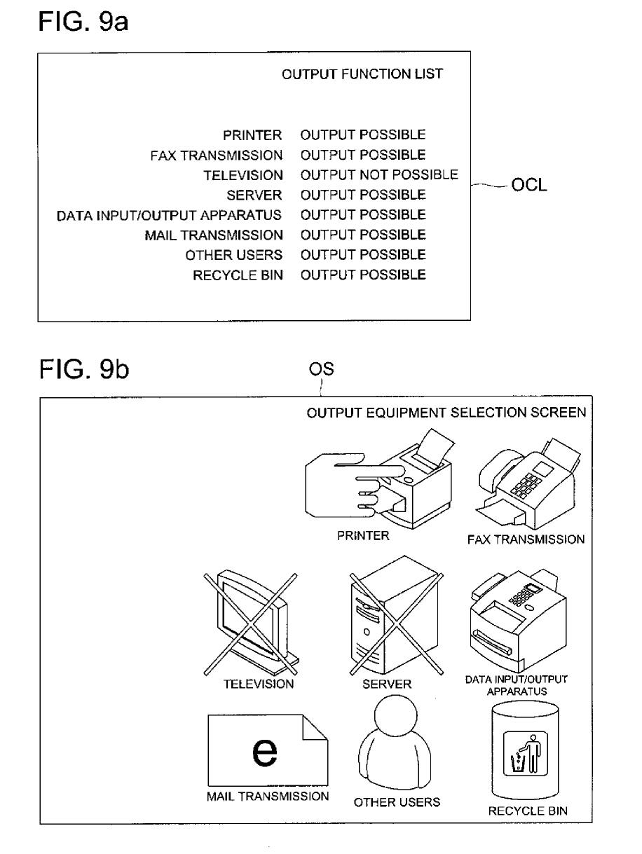

Further, the output functions list OCL is a list such as the one shown in FIG. 9(a), and the results of comparisons made in Step S403 are described in this list. In this example, for example, if the document input from the scanner is a text document, it is indicated in this list that output to the function 335 of displaying on a TV is not possible among the listed eight output functions, and output is possible to the other functions, namely, the function 331 of printing from a printer, the fax transmission function 333, the function 337 of data transmission to a server, or to a personal computer (PC), or to a storage apparatus, the function 339 of data transmission to another data input/output apparatus (MFP) or to another data input/output system, the mail transmission function 341, the function 343 of data transmission to other users, and the function 345 of discarding to the recycle bin.

Returning to FIG. 4, in Step S405, based on the output functions list OCL prepared in Step S403, a confirmation is made by the data control section 101 as to whether or not it is necessary to request the user to select the output function. If there is only one output function to which output can be made, it is judged that it is not necessary to make a selection (NO in Step S405), and the operation returns as it is to Step S140 of the main routine. When there is a plurality of output functions to which outputting is possible, it is judged that it is necessary to make a selection (YES in Step S405), and in Step S411, a selection of the output function is requested from the data control section 101 to the display and operation comprehensive section 201 while appending the output functions list OCL prepared in Step S403.

In Step S413, considering that there may be situations in which usage restrictions have been placed for each user, the output functions list OCL is further filtered by the display and operation comprehensive section 201. For example, in case the user has not been permitted to access the server, the item of the server in the output functions list OCL shown in FIG. 9(a) is changed from output possible to output not possible. Subsequently, in Step S415, the output equipment selection screen OS is displayed in the display apparatus 221 via the display control section 211 by the display and operation comprehensive section 201. The Steps S401 to S413 function as the output possible/not possible judgment step, and the step S415 functions as the output possible/not possible display step.

Here, the output equipment selection screen OS is a screen such as the one shown in FIG. 9(b), in which, not only the icons representing all the output functions that can be used at that point of time (here, these are taken to be—the function 331 of printing from a printer, the fax transmission function 333, the function 335 of displaying on a TV, the function 337 of data transmission to a server, or to a personal computer (PC), or to a storage apparatus, the function 339 of data transmission to another data input/output apparatus (MFP) or to another data input/output system, the mail transmission function 341, the function 343 of data transmission to other users, and the function 345 of discarding to the recycle bin) among all the output functions provided in the data input/output system 1 are displayed, but also, among these functions, a clearly distinguishable indication is made for the functions to which output cannot be made indicating that output cannot be made to those functions (for example, by placing a cross mark ‘X’ on the icons representing the function 335 of displaying on a TV and the function 337 of data transmission to a server, or to a personal computer (PC), or to a storage apparatus).

Returning to FIG. 4, in Step S417, a confirmation is made as to whether or not the selection of the output equipment has been completed. The operation waits at Step S417 until the selection has been completed. Here, it is considered that the function 331 of printing from a printer has been selected by the user as the output function. When the selection has been completed (YES in Step S417), in Step S421, the name of the selected output function (for example, the function 331 of printing from a printer) is returned by the display and operation comprehensive section 201 to the data control section 101, and in Step S423, the function 331 of printing from a printer is set as the output function by the data control section 101. The Step S417 functions as the output function selection step.

FIG. 5 is the Step S160 “output parameter setting subroutine” of the main routine of FIG. 2.

In FIG. 5, in Step S601, the output parameter list OPL of the printer that is retained by the output equipment control 121 of the printer is referred to by the output equipment control 121 of the printer, and a judgment is made as to whether or not it is necessary to make any settings at the time of outputting when using the printer.

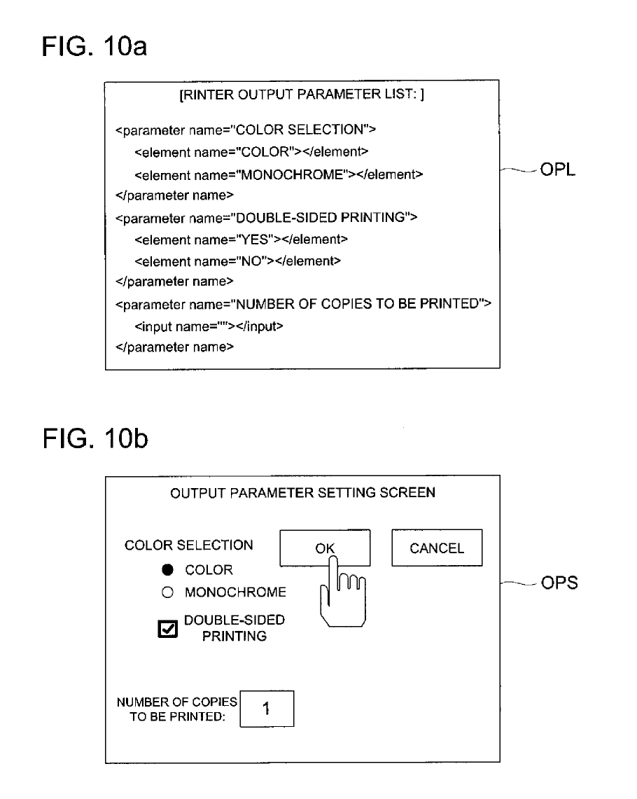

Here, the output parameter list OPL is a list such as the one shown in the example in FIG. 10(a), and for example, in the case of a printer, this list has entered in it the settings of the parameters such as color selection of color or monochrome printing, or double-sided printing, or the number of copies to be printed, etc.

If, at the time of outputting when using a printer, all the parameters have been determined unambiguously, and parameter setting is not necessary (NO in Step S601), the operation returns as it is to Step S160 in the main routine of FIG. 2.

In this example, from the output parameter list OPL of the printer shown in the example in FIG. 10(a), it is judged by the output equipment control 121 of the printer that settings are necessary for the three parameters of “color selection”, “double-sided printing”, and “number of copies to be printed” (YES in Step S601), and in Step S611, a request is made by the output equipment control 121 of the printer to the display and operation comprehensive section 201 for the settings of the parameters “color selection”, “double-sided printing”, and “number of copies to be printed”.

In Step S613, if there are any parameters that can be generated automatically among the parameters whose setting has been requested in Step S611, those parameters will be generated automatically by the display and operation comprehensive section 201 (here, it is considered that there are no parameters which can be generated automatically), in Step S615, the output parameter setting screen OPS is displayed in the display apparatus 221 via the display control section 211 by the display and operation comprehensive section 201.

Here, the output parameter setting screen OPS is a screen such as the example shown in FIG. 10(b), in which are displayed the parameters the inputs for which are required to be made by the user (here, the parameters of “color selection”, “double-sided printing”, and “number of copies to be printed”) along with the parameters whose settings have been generated automatically by the display and operation comprehensive section 201 (none, here in the example shown) The user not only inputs the settings (makes a selection or sets “color”, “double-sided printing”, and “one copy”) for the parameters for which input is being requested to be made (“color selection”, “double-sided printing”, and “number of copies to be printed”) by operating the operation apparatus 241 but can also make changes if necessary in the settings of the parameters that have been generated automatically.

In Step S617, a confirmation is made as to whether or not the input of parameters has been completed. The completion of input is confirmed, for example, when the fact that the “OK” button in the output parameter settings screen OPS has been pressed by the user is detected by the operation control section 241. The operation waits at Step S617 until the input is completed. When the input is completed (YES in Step S617), in Step S621, the three parameters of “color selection”, “double-sided printing”, and “number of copies to be printed” are returned by the display and operation comprehensive section 201 to the output equipment control 121 of the printer, and in Step S623, the parameters are set in the printer by the output equipment control 121 of the printer, and the operation returns to Step S160 of the main routine.

As has been explained above, while the display and operation comprehensive section 201 oversees the settings of the input and output parameters and the selection of the output equipment, for example, it is also possible to set up in advance some restrictions on the settings of the input and output equipment (for example, restricting print out to monochrome printing), etc., and it is also possible to generate input and output parameters automatically based on the settings, or to change the contents of the display made in the output equipment selection screen.

According to the preferred embodiment of the data input/output operation in a data input/output system 1 described above, for example, by the user carrying out the minimum amount of intuitive and interactive operations successively according to the flow of processing of the input data using the display apparatus 221 and the operation apparatus 241, such as by carrying out the operations of—selecting a scanner as the input equipment, starting operations from the intuitive input operation of setting the original document in the scanner and scanning it, after setting the input parameters and completing the input of all the original documents, selecting the output destination from the usable output equipment that are judged automatically from the format of the input data, and completing all the outputs by setting the output parameters, it is possible for the user to obtain easily and definitely the final result desired by the user of getting an output from a printer, and also it is possible to eliminate wrong operations.

As a consequence, whatever input equipment is used by the user, it is possible to start the input operations without bothering about the output equipment or the output parameters, and after all the inputs are completed, it is possible to select which output equipment to be used from the usable output equipment that is provided automatically by the data input/output system 1.

In addition, in the case in which the original purpose of the user is not merely to copy the paper original documents but to hand over the copied document to some person, even if the operations were started initially with the intention of copying, by looking at the display of the output equipment in which output can be made in Step S415 of FIG. 4, the user can notice the “mail transmission function” and execute that function. In other words, according to the present preferred embodiment, the user can not only use the output form that was initially intended by the user but also can carry out output in a more desirable form.

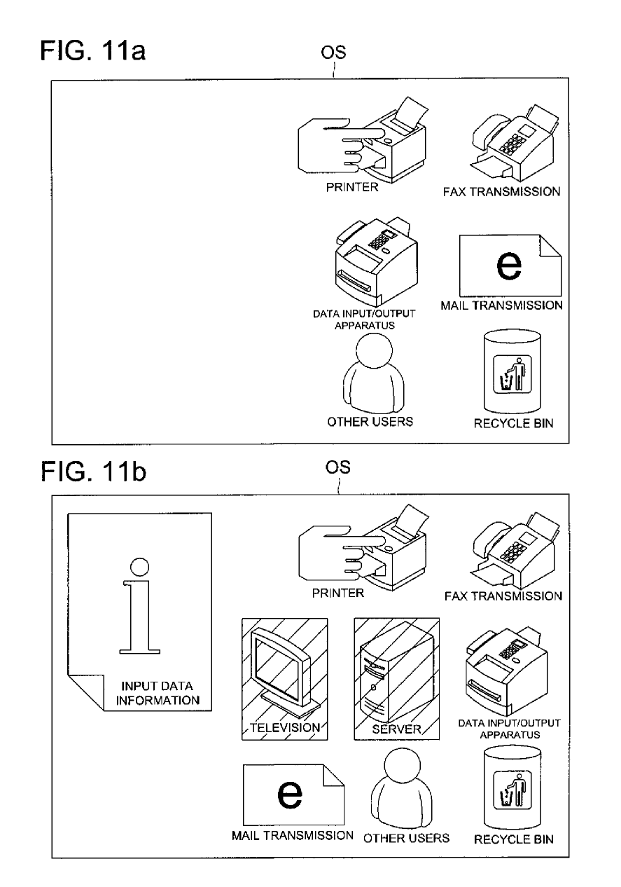

Next, a second and a third example of the output equipment selection screen OS are explained using FIGS. 11(a) and FIG. 11(b). FIG. 11(a) is a schematic diagram showing a second example of the output equipment selection screen OS, and FIG. 11(b) is a schematic diagram showing a third example of the output equipment selection screen OS.

In FIG. 11(a), differing from the first example of the output equipment selection screen OS shown in FIG. 9(b), only the output functions in which output is possible are displayed among all the output functions provided in the data input/output system 1, and the output functions in which output is not possible are not displayed. Taking the same example as of FIG. 9(b), the icons representing the functions—the function 331 of printing from a printer, the fax transmission function 333, the function 339 of data transmission to another data input/output apparatus (MFP) or to another data input/output system, the mail transmission function 341, the function 343 of data transmission to other users, and the function 345 of discarding to the recycle bin
are displayed, but the icons representing the function 335 of displaying in a TV and the function 337 of data transmission to a server, or to a personal computer (PC), or to a storage apparatus are not displayed.

According to the second example of the output equipment selection screen OS described above, in addition to the effect of the first example, since the output equipment in which “output is not possible” are not displayed, it is possible to prevent the user from wrongly selecting such output equipment. In addition, it is possible to display more or larger icons of the output equipment in which “output is possible” in the display apparatus 221 with a limited size, and the selection of the output equipment by the user becomes still easier.

In FIG. 11(b), differing from the first and second examples of the output equipment selection screen OS shown in FIG. 9(b) and FIG. 11(a), the information related to the input data (for example, data name, data format, icon representing the data format, etc.,) are displayed in the display apparatus 221. The user can use this information as a guide for selecting the output equipment.

In addition, icons representing all the output equipment provided in the data input/output system 1 are displayed, and among those, the output functions through which output can be made are displayed so that they can easily be distinguished (for example, displaying the icon brightly, or making the icon blink, etc.), and also, the output functions through which output cannot be made are also displayed so that they can be distinguished easily (for example, displaying the icon dimly or transparently, or placing hatches on the icon, etc.). Or else, even if the user selects an output function through which output cannot be made, it is possible take measures such as not to accept that selection and to give a warning sound or warning message, etc.

According to the third example of the output equipment selection screen OS described above, in addition to the effect of the first example, by providing the user with the information on the input data 113 which is the target to be output, the judgment becomes still easier at the time that the user selects the output means.

As has been explained above, according to the present invention, in a data input/output system provided with input equipment and output equipment, by judging and displaying whether or not an output equipment can output the input data input from input equipment, it is possible to provide a data input/output system, a control method and control apparatus for a data input/output system in which the selection of the output equipment for outputting the input data can be made easily and definitely with the least number of operations, and wrong operations can be eliminated.

Further, regarding the detailed constitutions of the different constitutions and the detailed operation of the data input/output system, the control method and control apparatus for the data input/output system according to the present invention, it is possible to make appropriate modifications without deviating from the purpose and intent of the present invention.

1. A data input/output system comprising:
a plurality of input equipments to input data;
a plurality of output equipments to output data;
a data control section that is connected to said plurality of input equipments and said plurality of output equipments, and receives input data that has been input from any of said plurality of input equipments, and outputs the received input data to any of said plurality of output equipments;
an output possible/not possible judgment section that receives information related to each of the output equipment from said plurality of output equipments, compares information related to said input data associated with the input data with the received information related to each of the output equipment, and judges whether or not it is possible to output the input data in each of the output equipment;
a display apparatus; and
a display control section that displays in said display apparatus the results of judgment by said output possible/not possible judgment section.

2. A data input/output system according to claim 1, wherein said display control section displays the results of judgment by said output possible/not possible judgment section in said display apparatus so that it is possible to distinguish said output equipment in which it is not possible to output said input data.

3. A data input/output system according to claim 1, wherein said display control section displays the results of judgment by said output possible/not possible judgment section in said display apparatus so that it is possible to distinguish said output equipment in which it is possible to output said input data.

4. A data input/output system according to claim 1, wherein said display control section displays in said display apparatus only said output equipment in which it is possible to output said input data.

5. A data input/output system according to claim 1, further comprising:
an operation apparatus to input information that is used for outputting the input data in said output equipment; and
an operation control section that—obtains the information related to the selection of the output equipment that is input from said operation apparatus, when a plurality of output equipment are present in which it is possible to output said input data according to the results of judgment by said output possible/not possible judgment section, and sets the output equipment that has been selected as the output equipment in which said input data has to be output.

6. A data input/output system according to claim 5, wherein said operation control section obtains information related to the parameter settings of said input equipment which is input from said operation apparatus.

7. A data input/output system according to claim 5, wherein said operation control section obtains information related to the parameter settings of said output equipment which is input from said operation apparatus.

8. A data input/output system according to claim 6, wherein said output possible/not possible judgment section, based on the information related to the parameter settings of said input equipment obtained from said operation control section, judges whether or not said output equipment can output said input data.

9. A data input/output system according to claim 7, wherein said output possible/not possible judgment section, based on the information related to the parameter settings of said output equipment obtained from said operation control section, judges whether or not said output equipment can output said input data.

10. A data input/output system according to claim 5, wherein said operation apparatus is a touch panel placed above said display apparatus.

11. A control method of a data input/output system, the system comprising:
a plurality of input equipments to input data;
a plurality of output equipments to output data;
a data control section that is connected to said plurality of input equipments and said plurality of output equipments, receives input data that has been input from any of said plurality of input equipment, and outputs the received input data to any of said plurality of output equipment; and
a display apparatus,
the method comprising:
an input step of inputting data;
an output information reception step of receiving the information related to said output equipment from said plurality of output equipment,
an output possible/not possible judgment step of comparing information related to the input data associated with the input data received during said input step with the information related to said plurality of output equipments that has been received during said output information reception step, and judging whether or not said plurality of output equipments can output the input data; and
an output possible/not possible display step of displaying in said display apparatus the results of judgment made during said output possible/not possible judgment step.

12. A control apparatus of a data input/output system provided with a plurality of input equipments for inputting data and a plurality of output equipments for outputting data, the control apparatus comprising;
a data control section that is connected to said plurality of input equipments and said plurality of output equipments, receives input data that has been input from any of said plurality of input equipments, and outputs said the received input data to any of said plurality of output equipments;
an output possible/not possible judgment section that receives information related to each of the output equipment from said plurality of output equipments, compares the information related to said input data associated with the input data with the received information related to each of said plurality of output equipments, and judges whether or not that each of the said output equipment can output said input data;
a display apparatus; and
a display control section that displays in said display apparatus the results of judgment made by said output possible/not possible judgment section.
